(19) United States
(12) Patent Application Publication
(10) Pub. No.: US 2026/0188101 A1
(43) Pub. Date: Jul. 2, 2026

(54) WEARABLE WIRELESS TRACKING DEVICE

(71) Applicant: Veronica Torres, Tucson, AZ (US)

(72) Inventor: Veronica Torres, Tucson, AZ (US)

(21) Appl. No.: 19/008,145

(22) Filed: Jan. 2, 2025

(51) Int. Cl. G08B 25/01; G08B 25/10; G08B 25/12; H04W 4/029; H04W 4/90

(52) U.S. Cl. CPC G08B 25/016; G08B 25/10; G08B 25/12; H04W 4/029; H04W 4/90

(57) ABSTRACT

A wearable wireless tracking device includes a housing and a connector coupled to the housing. The connector is wearable. A microprocessor, a wireless transceiver, a wireless transmitter, and a battery are disposed in the housing. A switch is disposed in the housing to activate the microprocessor, the wireless transceiver, and the wireless transmitter. The switch includes a movable contact selectively movable into engagement with a stationary contact to activate the microprocessor. An activator is attached to the movable contact and designed to be selectively moved out through an orifice in the housing to move the movable contact into engagement with the stationary contact. A pull element is coupled to the activator to be manually grasped to pull the activator and actuate the switch.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (g) BACKGROUND OF THE INVENTION

### (1) Field of the Invention

The disclosure relates to wireless tracking devices and emergency devices and more particularly pertains to a new wearable wireless tracking device for providing location data of a person wearing the wearable wireless tracking device, as well as automatically communicating with emergency services.

### (2) DESCRIPTION OF RELATED ART INCLUDING INFORMATION DISCLOSED UNDER 37 CFR 1.97 and 1.98.

The prior art relates to wireless tracking devices and emergency devices of various designs. The prior art, as best understood, does not disclose a wearable wireless tracking device includes a housing and a connector coupled to the housing, which connector is wearable. A switch is disposed in the housing to activate the wearable wireless tracking device, wherein the switch is connected to a pull element that is outside the housing and is designed to be manually grasped and pulled to actuate the switch.

### (h) BRIEF SUMMARY OF THE INVENTION

An embodiment of the disclosure meets the needs presented above in a wearable wireless tracking device generally comprising a housing and a connector coupled to the housing. The connector is wearable. A microprocessor is disposed in the housing. A wireless transceiver is disposed in the housing. The wireless transceiver is connected to the microprocessor. The wireless transceiver is connectable to a global positioning system to transmit location data of the housing. A wireless transmitter is disposed in the housing. The wireless transmitter is connected to the microprocessor. The wireless transmitter is connectable to an emergency service system to transmit an emergency signal. A battery is disposed in the housing. The battery is connected to the microprocessor, the wireless transceiver, and the wireless transceiver. A switch is disposed in the housing. The switch is connected to the microprocessor to activate the microprocessor, the wireless transceiver, and the wireless transmitter. The switch includes a movable contact and a stationary contact. The movable contact is selectively movable into engagement with the stationary contact to activate the microprocessor. An activator is attached to the movable contact in the housing. The activator is designed to be selectively moved out through an orifice in the housing to move the movable contact into engagement with the stationary contact. A pull element is coupled to the activator. The pull element is designed to be manually grasped to pull the activator and actuate the switch.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wearable wireless tracking device according to an embodiment of the disclosure.

FIG. 2 is a rear perspective view of an embodiment of the disclosure.

FIG. 3 is a rear perspective view of an embodiment of the disclosure.

FIG. 4 is a front detail view of an embodiment of the disclosure.

FIG. 5 is a front detail view of an embodiment of the disclosure.

FIG. 6 is a schematic view of an embodiment of the disclosure in use.

FIG. 7 is a perspective view of a first alternative embodiment of the disclosure.

FIG. 8 is a perspective view of a second alternative embodiment of the disclosure.

### (j) DETAILED DESCRIPTION OF THE INVENTION

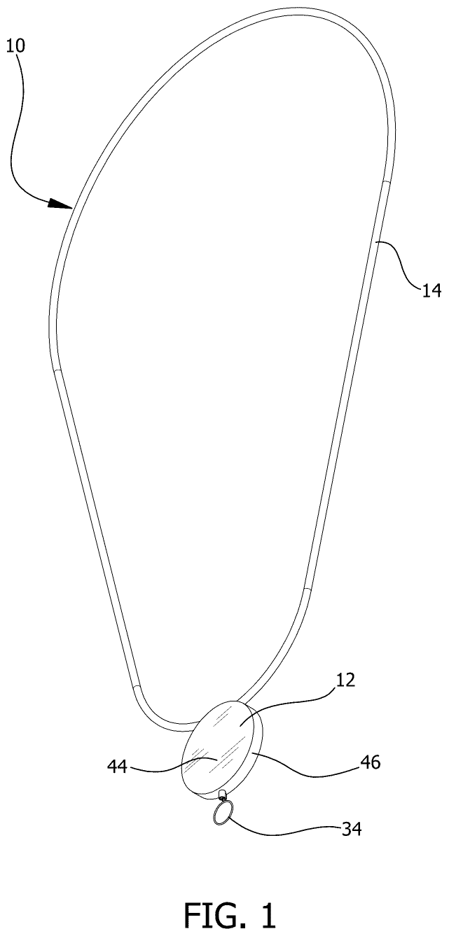

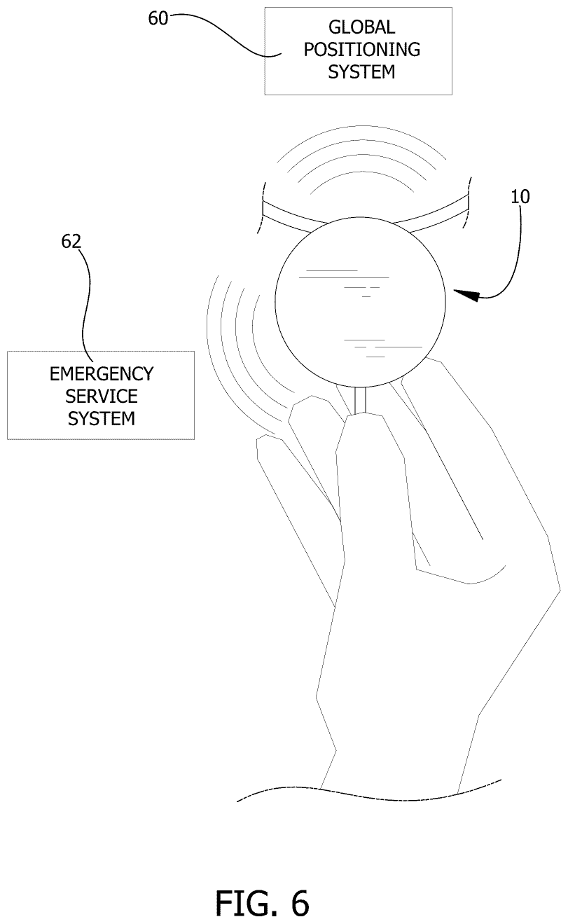

With reference now to the drawings, and in particular to FIGS. 1 through 8 thereof, a new wearable wireless tracking device embodying the principles and concepts of an embodiment of the disclosure and generally designated by the reference numeral 10 will be described.

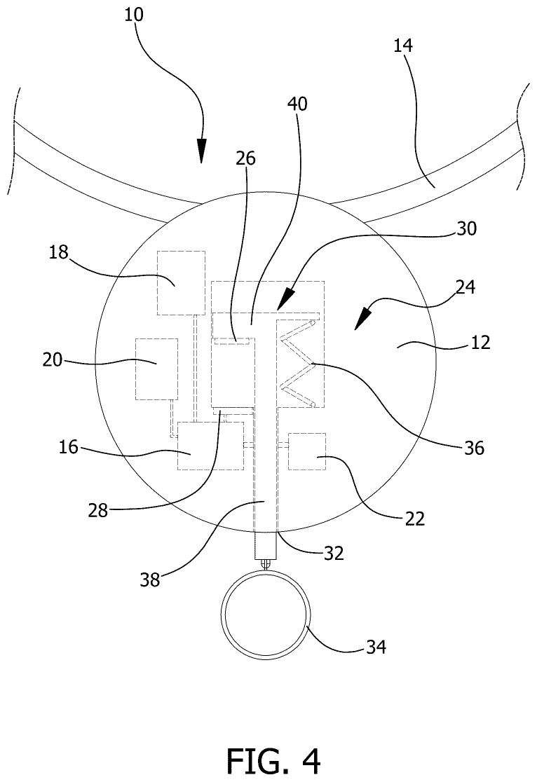

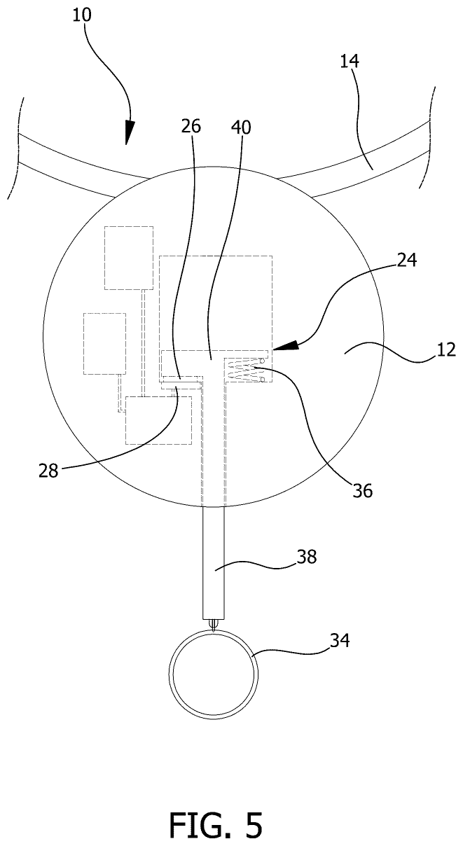

As best illustrated in FIGS. 1 through 8, the wearable wireless tracking device 10 generally comprises a housing 12 and a connector 14 coupled to the housing 12. The connector 14 is wearable. As best seen in FIGS. 4 and 5, a microprocessor 16 is disposed in the housing 12. A wireless transceiver 18 is disposed in the housing 12. The wireless transceiver 18 is connected to the microprocessor 16. The wireless transceiver 18 is connectable to a global positioning system 60 to transmit location data of the housing 12. A wireless transmitter 20 is disposed in the housing 12. The wireless transmitter 20 is connected to the microprocessor 16. The wireless transmitter 20 is connectable to an emergency service system 62 to transmit an emergency signal. A battery 22 is disposed in the housing 12. The battery 22 is connected to the microprocessor 16, the wireless transceiver 18, and the wireless transceiver 18. A switch 24 is disposed in the housing 12. The switch 24 is connected to the microprocessor 16 to activate the microprocessor 16, the wireless transceiver 18, and the wireless transmitter 20. The switch 24 includes a movable contact 26 and a stationary contact 28. The movable contact 26 is selectively movable into engagement with the stationary contact 28 to activate the microprocessor 16. An activator 30 is attached to the movable contact 26 in the housing 12. The activator 30 is designed to be selectively moved out through an orifice 32 in the housing 12 to move the movable contact 26 into engagement with the stationary contact 28. A pull element 34 is coupled to the activator 30. The pull element 34 is designed to be manually grasped to pull the activator 30 and actuate the switch 24.

As shown in FIG. 4, the switch 24 includes a resilient element 36 in engagement with the activator 30 to bias the movable contact 26 away from the stationary contact 28. The activator 30 compresses the resilient element 36 when the activator 30 is pulled. In the exemplary embodiment, the resilient element 36 is a spring. In the exemplary embodiment in FIGS. 4 and 5, the activator 30 includes a rod 38 and a head 40 attached to the rod 38. The movable contact 26 is mounted on the head 40. The head 40 is in engagement with the resilient element 36, wherein the head 40 could be attached to the spring or in free contact with the spring.

The housing 12 includes a back wall 42, a front wall 44, and a perimeter wall 46 connecting the back wall 42 and the front wall 44. The orifice 32 is disposed in the perimeter wall 46. In the exemplary embodiment, the front wall 44 and the back wall 42 are circular and the perimeter wall 46 is round to form a cylindrical disk, though other shapes are well within the scope of the disclosure.

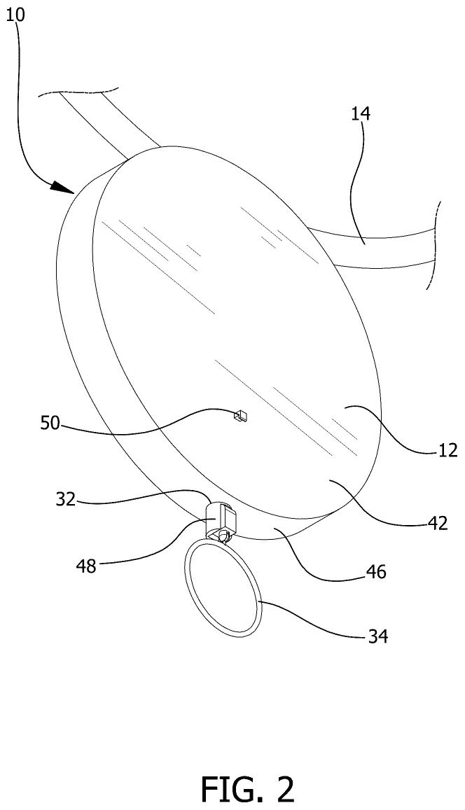

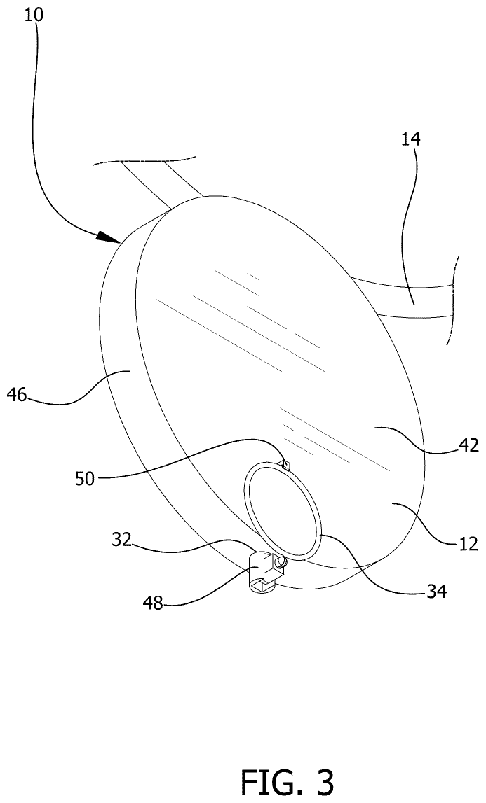

In the exemplary embodiment in FIGS. 2 and 3, the activator 30 includes a pivot joint 48 projecting beyond the perimeter wall 46. The pivot joint 48 is pivotable between a straight position (FIG. 2) parallel to the back wall 42 and a bent position perpendicular to the back wall 42 (FIG. 3). The pull element 34 is pivotably connected to the pivot joint 48, such that when the pivot joint 48 is in the bent position the pull element 34 is pivotable to a storage position against the back wall 42. The back wall 42 includes a retainer 50 designed to engage and hold the pull element 34 in the storage position. The storage position helps minimize accidental or unintentional activation of the wearable wireless tracking device 10.

In the exemplary embodiment, the pull element 34 is a ring pivotably coupled to the activator 30. However, in another possible embodiment the pull element 34 could be a tab or hook or other such shape that is easily grasped by hand. The pull element 34 design makes it easier for a user to find and activate the wearable wireless tracking device 10, which is advantageous in high stress emergency situations when the user might be compromised or distracted.

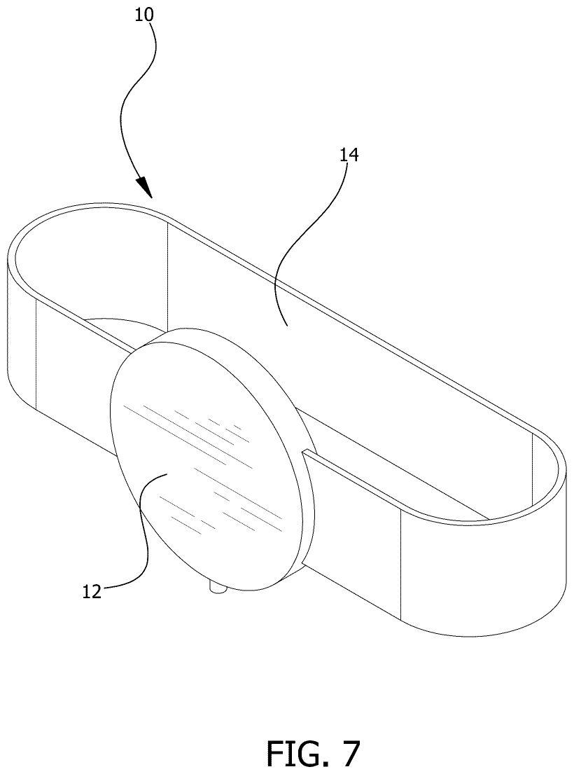

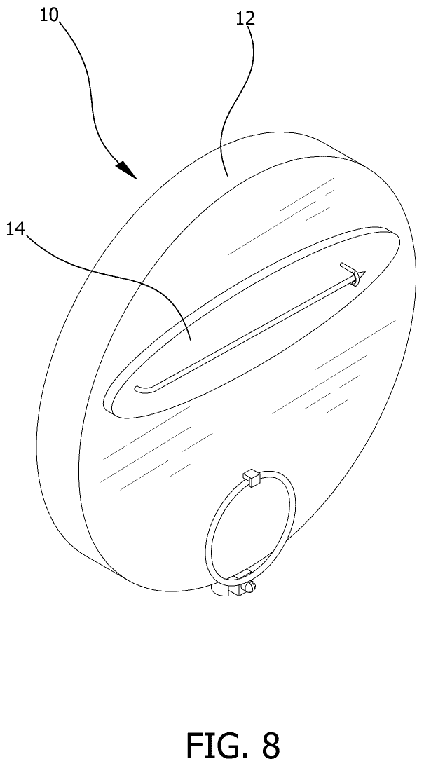

In FIGS. 1 through 6, the connector 14 is a necklace. In FIG. 7, the connector 14 is a wristband. In FIG. 8, the connector 14 is a pin designed to be fastened to an article of clothing. These are three examples, but other wearable connections, such as clasps or buttons or magnets, are within the scope of the disclosure.

FIGS. 4 through 6 show the use of the wearable wireless tracking device 10. In an emergency situation, such as an injury or threatening encounter with other persons or animals, a user can pull the ring to activate the switch 24. The wireless transceiver 18 connects to a global positioning system 60 to transmit location data of the housing 12, and thus the location of the user wearing the wearable wireless tracking device 10. The wireless transmitter 20 is also connected to an emergency service system 62 to transmit an emergency signal as well as the location data received from the global positioning system 60 so that public services, such as law enforcement or emergency medical services, can be summoned to the location of the user for aid.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wearable wireless tracking device comprising:
a housing;
a connector being coupled to said housing, said connector being wearable;
a microprocessor being disposed in said housing;
a wireless transceiver being disposed in said housing, said wireless transceiver being connected to said microprocessor, said wireless transceiver being connectable to a global positioning system to transmit location data of said housing;
a wireless transmitter being disposed in said housing, said wireless transmitter being connected to said microprocessor, said wireless transmitter being connectable to an emergency service system to transmit an emergency signal;
a battery being disposed in said housing, said battery being connected to said microprocessor, said wireless transceiver, and said wireless transceiver;
a switch being disposed in said housing, said switch being connected to said microprocessor to activate said microprocessor, said wireless transceiver, and said wireless transmitter, said switch including a movable contact and a stationary contact, said movable contact being selectively movable into engagement with said stationary contact to activate said microprocessor;
an activator being attached to said movable contact in said housing, said activator being configured to be selectively moved out through an orifice in said housing to move said movable contact into engagement with said stationary contact; and
a pull element being coupled to said activator, said pull element being configured to be manually grasped to pull said activator and actuate said switch.

2. The wearable wireless tracking device of claim 1, wherein:
said switch includes a resilient element in engagement with said activator to bias said movable contact away from said stationary contact; and
said activator compresses said resilient element when said activator is pulled.

3. The wearable wireless tracking device of claim 1, wherein:
said housing includes a back wall, a front wall, and a perimeter wall connecting said back wall and said front wall; and
said orifice is disposed in said perimeter wall.

4. The wearable wireless tracking device of claim 3, wherein:
said activator includes a pivot joint projecting beyond said perimeter wall;
said pivot joint is pivotable between a straight position parallel to said back wall and a bent position perpendicular to said back wall;
said pull element is pivotably connected to said pivot joint, such that when said pivot joint is in said bent position said pull element is pivotable to a storage position against said back wall;
said back wall includes a retainer configured to engage and hold said pull element in said storage position;

5. The wearable wireless tracking device of claim 1, wherein said pull element is a ring pivotably coupled to said activator.

6. The wearable wireless tracking device of claim 2, wherein.
said activator includes a rod and a head attached to said rod;
said movable contact is mounted on said head; and
said head is in engagement with said resilient element.

7. The wearable wireless tracking device of claim 1, wherein said connector is a necklace.

8. The wearable wireless tracking device of claim 1, wherein said connector is a wristband.

9. The wearable wireless tracking device of claim 1, wherein said connector is a pin configured to be fastened to an article of clothing.

10. The wearable wireless tracking device of claim 2, wherein:
said housing includes a back wall, a front wall, and a perimeter wall connecting said back wall and said front wall; and
said orifice is disposed in said perimeter wall.

11. The wearable wireless tracking device of claim 10, wherein:
said activator includes a pivot joint projecting beyond said perimeter wall;
said pivot joint is pivotable between a straight position parallel to said back wall and a bent position perpendicular to said back wall;
said pull element is pivotably connected to said pivot joint, such that when said pivot joint is in said bent position said pull element is pivotable to a storage position against said back wall;
said back wall includes a retainer configured to engage and hold said pull element in said storage position;

12. The wearable wireless tracking device of claim 11, wherein said pull element is a ring pivotably coupled to said activator.

13. The wearable wireless tracking device of claim 12, wherein.
said activator includes a rod and a head attached to said rod;
said movable contact is mounted on said head; and
said head is in engagement with said resilient element.

14. The wearable wireless tracking device of claim 13, wherein said connector is a necklace.

15. The wearable wireless tracking device of claim 13, wherein said connector is a wristband.

16. The wearable wireless tracking device of claim 13, wherein said connector is a pin configured to be fastened to an article of clothing.
